(19) United States
(12) Patent Application Publication
(10) Pub. No.: US 2026/0179076 A1
(43) Pub. Date: Jun. 25, 2026

(54) FUND TRANSFERS ON VOICE CALLS

(71) Applicant: T-Mobile USA, Inc., Bellevue, WA (US)

(72) Inventors: Harikishore Allu Balan, Lynnwood, WA (US); Prasathkumar Chandrasekaran, Bellevue, WA (US); Jagannadha Anudeep Varma Datla, Bellevue, WA (US)

(21) Appl. No.: 18/989,582

(22) Filed: Dec. 20, 2024

(51) Int. Cl. G06Q 20/32; G06Q 20/10; G06Q 20/40; H04L 65/1104

(52) U.S. Cl. CPC G06Q 20/325; G06Q 20/10; G06Q 20/4014; H04L 65/1104

(57) ABSTRACT

Methods, devices, and systems related to fund transfers during voice calls are disclosed. In one example aspect, a method for enabling a fund transfer during a voice call includes initiating, by a mobile device of a first user, a procedure to establish a session initiation protocol (SIP) session for the voice call. The method includes receiving an indication from the first user to initiate the fund transfer to a second user during the voice call, transmitting an SIP update message to update the SIP session established with an additional data channel, transmitting biometric user data to a banking system via the data channel to enable the banking system to authenticate the first user, and transmitting information about the second user to the banking system via the data channel to complete the fund transfer to the second user.

### BACKGROUND

Mobile communication technologies are moving the world toward an increasingly connected and networked society. The rapid growth of mobile communications and advances in technology have led to greater demand for capacity and connectivity. In particular, the connection between mobile communication and financial services has grown significantly over the past few decades, transforming the way financial transactions are conducted and managed. This intersection has led to the development of mobile banking, mobile payments, and other financial technologies that leverage mobile communication to provide convenient, efficient, and secure financial services.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates Fifth Generation (5G) core network functions (NFs) that can implement aspects of the present technology.

FIG. 3 illustrates an example of fund transfer using a billing application installed on a mobile device.

FIG. 4 is an example signaling flow at a core network level for a fund transfer using a billing application.

FIG. 5 is a flowchart representation of a method for wireless communication in accordance with one or more embodiments of the present technology.

FIG. 6A illustrate an example user interface during a voice call in accordance with one or more embodiments of the present technology.

FIG. 6B illustrate another example user interface during a voice call in accordance with one or more embodiments of the present technology.

FIG. 6C illustrate yet another example user interface during a voice call in accordance with one or more embodiments of the present technology.

FIG. 7 is a flowchart representation of a method for wireless communication in accordance with one or more embodiments of the present technology.

FIG. 8A illustrates an example signaling flow of a fund transfer during a voice call in accordance with one or more embodiments of the present technology.

FIG. 8B illustrates another example signaling flow of a fund transfer during a voice call in accordance with one or more embodiments of the present technology.

FIG. 9 illustrates an example signaling flow of obtaining a line of credit during a voice call in accordance with one or more embodiments of the present technology.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

An electronic fund transfer (EFT) is the electronic transfer of money from one bank account to another, either within a single financial institution or across multiple institutions. Users can use cash management applications installed on their personal devices, such as PayPal or Venmo, to send and receive money by linking their bank account(s) using either phone number(s) or personal email account(s).

Some of the fund transfer requests originate in communications between families and friends (e.g., voice calls, video calls, etc.), but currently users are required to initiate the transfers using the applications after the voice calls are complete. This patent document discloses techniques that can be implemented in various embodiments to facilitate fund transfers between accounts during on-going sessions, such as voice calls and/or video calls. The disclosed techniques allow modifications to the existing session initiation protocol (SIP) sessions. By adding additional data channels to SIP sessions, accurate and safe fund transfers can occur, thereby providing enhanced user experience.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

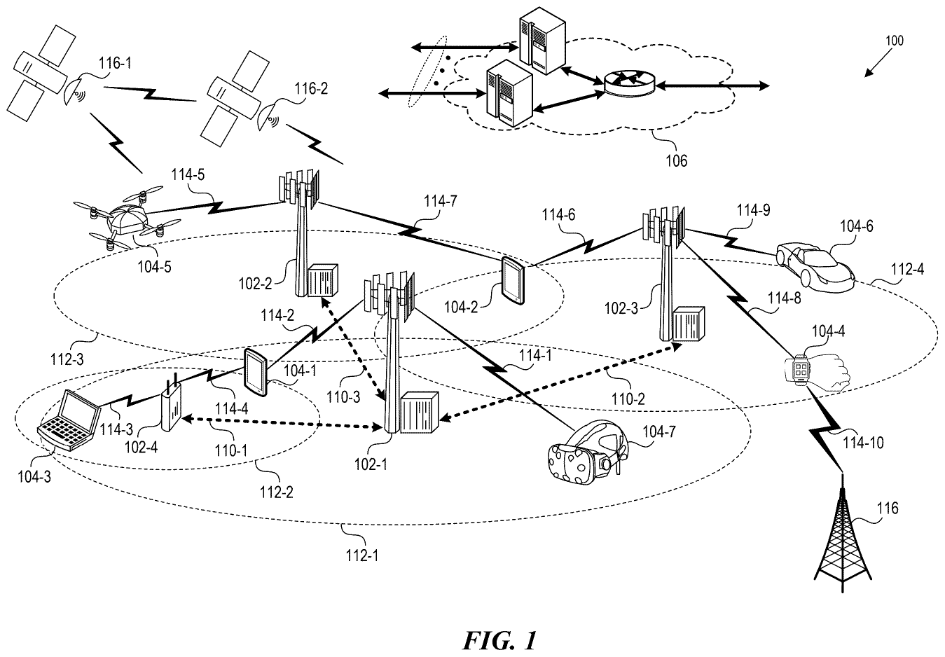

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

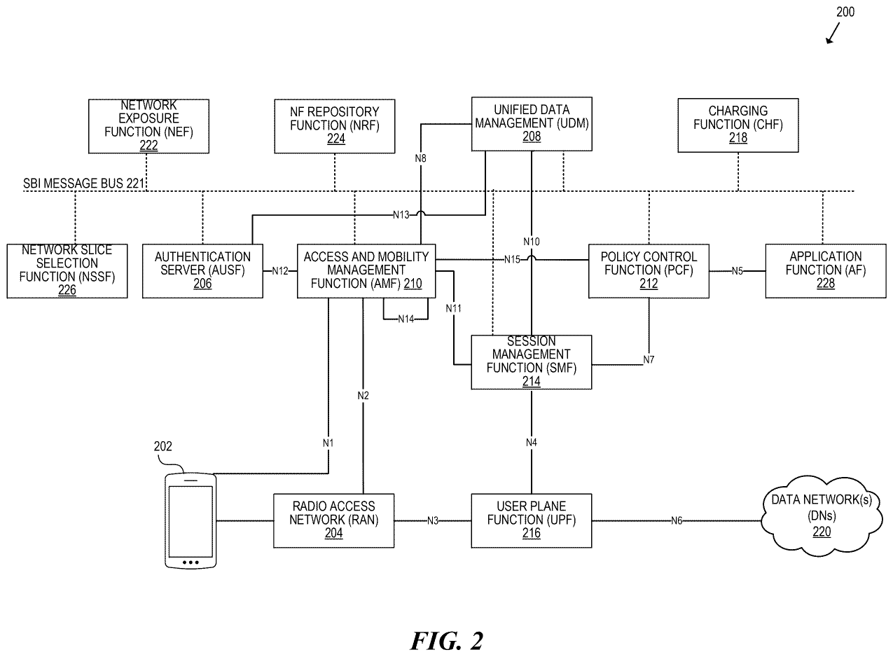

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

The fund transfer process includes electronic messages sent between financial institutions directed to make the debit and credit accounting entries necessary to complete the transaction. Various types of funds can be transferred, including cash, balances in different accounts, different currencies in different countries, and/or cryptocurrencies. For example, funds can be stored in bank accounts, digital wallets, and/or third-party accounts (e.g., PayPal, Square, Cash App, etc.). The parties that may be involved in a fund transfer transaction include (1) an originator, e.g., individual, business entity—the initiator of a fund transfer; (2) a beneficiary—the party to be credited or paid as a result of a fund transfer; (3) the originator's financial institution—the financial institution receiving the transfer instructions from the originator and transmitting the instructions to the next party in the fund transfer; and (4) the beneficiary's financial institution—the financial institution that is to credit or pay the beneficiary party. In some cases, additional financial institutions may be required to complete the transaction (e.g., as an intermediate routing stop for the fund transfer, or to convert the different currencies).

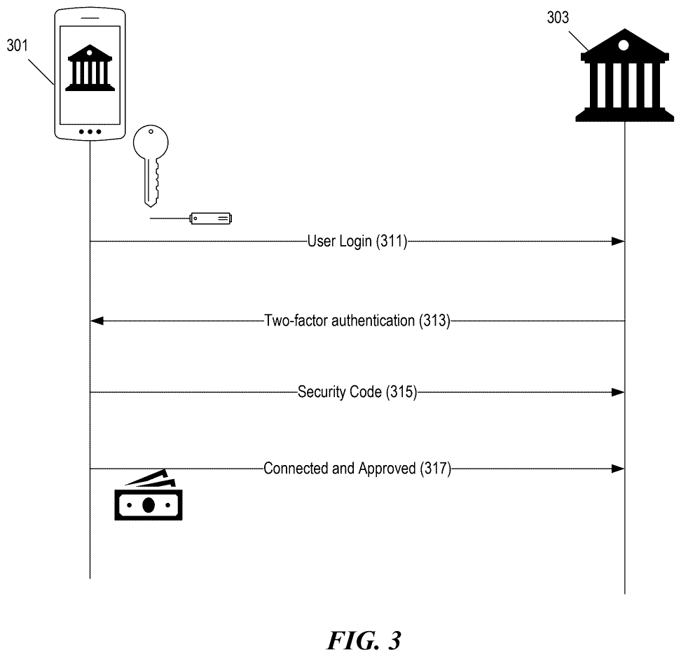

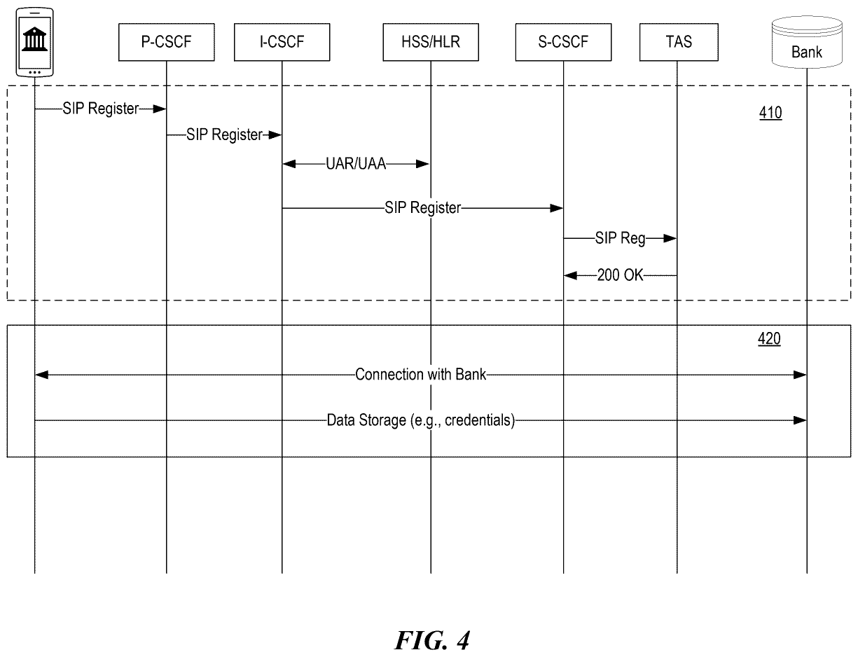

Currently, transferring funds using a mobile device requires a user to open a billing or a cash management application (e.g., a banking application, PayPal, Cash App, or Venmo). FIG. 3 illustrates an example of a fund transfer using a billing application installed on a mobile device. To initiate and complete a fund transfer, the user needs to first log in to the billing application, at operation 311, on the user device 301 to connect to the bank 303. After a two-factor authentication process 313 that involves sending the user a notification (e.g., via Short Message Service, SMS) and receiving a security code at operation 315, the connection to the bank account is authenticated at operation 317. The user then sends a fund transfer request, which is approved according to the authentication and verification of the financial information. FIG. 4 is an example signaling flow at the core network level for a fund transfer using a billing application. The user device first performs Internet Protocol (IP) Multimedia Subsystem (IMS) registration procedure 410. In the IMS registration procedure 410, the user device sends a session initiation protocol (SIP) register message to a Proxy Call Session Control Function (P-CSCF), which forwards the message to an Interrogating CSCF (I-CSCF). The I-CSCF performs a User-Authorization-Request (UAR)/User-Authorization-Answer (RAA) procedure with the Home Subscriber Server (HSS)/Home Location Register (HLR) and continues the SIP registration process. Subsequently, the billing application can connect to the banking server via a data channel that is established separately from the SIP session at operation 420.

In some embodiments, the user has logged into the billing application (e.g., an application provided by the communication service provider) so that a secure connection between the communication service account and the user's bank account can be established using user's authentication and authorization information. After the authentication, the secure data channel to the banking server is established without further input from the user. In some embodiments, the user may be prompted to log-in again or update the authentication/authorization information so that the billing application and the bank network stay synchronized.

Some of the fund transfer requests, especially smaller amounts of transfers, originate in communications between families and friends. For example, friends or families may call each other to help order small items, which result in transfers of small amounts. Currently, a user needs to log in into the billing application after the voice call to enter the agreed amount for the transfer. Sometimes the user may not be able to complete the transfer right away (e.g., the user is driving while making the voice call). Occasionally the user may inadvertently enter the wrong amount and need to have separate transactions to correct the transferred amount. This patent document discloses techniques that can be implemented in various embodiments to facilitate fund transfers between verified accounts during ongoing communication sessions (e.g., voice calls, video calls, etc.), ensuring accurate and safe transfers while providing enhanced user experience. The descriptions below use voice calls as examples, but the disclosed techniques can be implemented in other SIP sessions such as video calls.

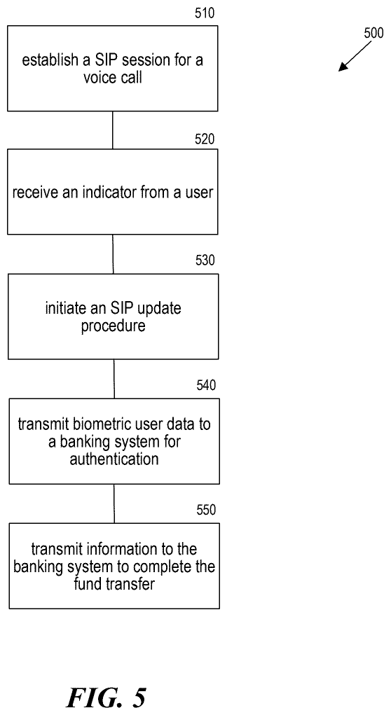

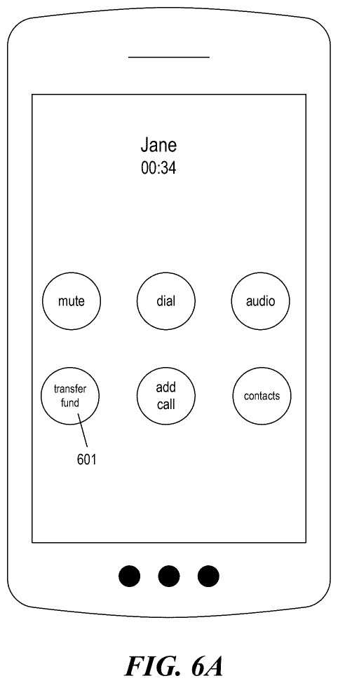

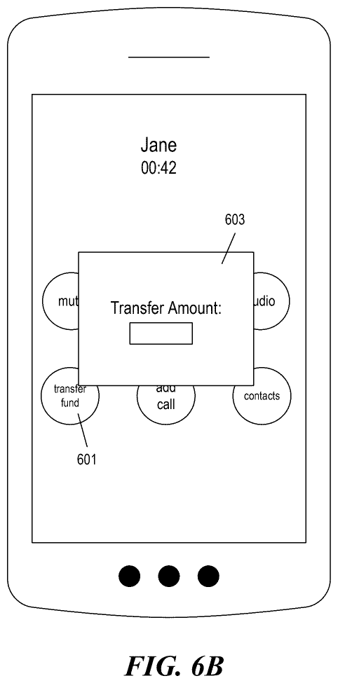

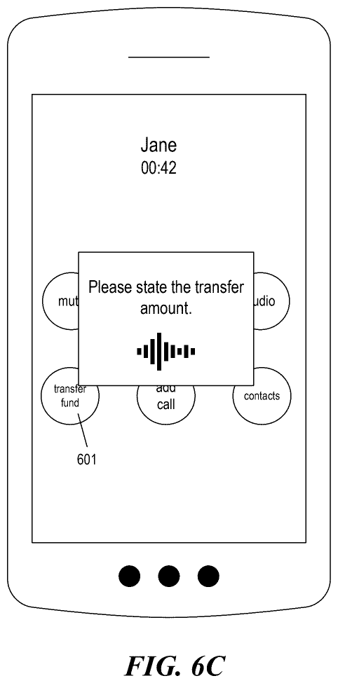

FIG. 5 is a flowchart representation of a method for wireless communication in accordance with one or more embodiments of the present technology. The method 500 includes initiating, by a mobile device of a first user at operation 510, a procedure to establish a SIP session for a voice call. In a SIP session, the Session Description Protocol (SDP) payload carried in SIP messages usually uses the Real-time Transport Protocol (RTP) or the Secure Real-time Transport Protocol (SRTP) to transmit media streams like voice and video. The method 500 includes receiving, by the mobile device at operation 520, an indication from the first user. The indication initiates the fund transfer to a second user during the voice call. In some embodiments, the indication can be received from the voice call interface. FIGS. 6A-C illustrate an example user interface during a voice call in accordance with one or more embodiments of the present technology. In this example, the user initiated a voice call to Jane. During the voice call, if the call interface is visible to the user (e.g., the user is facing the device while making the voice call), the user can tap on the interface control 601 (e.g., a button) to initiate the fund transfer. Upon the interface control 601 being tapped, a pop-up window 603 can be displayed to the user, such as shown in FIG. 6B, to enable the user to enter the accurate amount. In some embodiments, voice recognition techniques can be used to recognize the transfer amount (e.g., as shown in FIG. 6C) so that the user is not required to enter it via the interface. In some embodiments, voice recognition techniques can be used to automatically detect a voice trigger to initiate the fund transfer. For example, a key phrase or sentence stated in the voice call (e.g., “I'd like to transfer funds to you”) can be recognized as the indication to trigger/initiate the fund transfer. The user can further state the desired amount, which is then recognized using voice recognition techniques for subsequent operations.

Referring back to FIG. 5, the method 500 includes initiating, by the mobile device at operation 530, an SIP update procedure to update the SIP session established for the voice call. The SIP update message comprises one or more parameters to establish an additional data channel for the SIP session. The additional data channel is separate from the existing channel using in SDP (via RTP or SRTP) to carry authentication and/or fund information. The method 500 includes transmitting, by the mobile device at operation 540, biometric user data to a banking system associated with the first user via the data channel to enable the banking system to authenticate the first user. As discussed above, the banking system includes systems that used by various financial institutes, such as conventional banks, digital wallets, cryptocurrency management platforms, and/or third-party cash management entities such as PayPal, Square, Venmo, Cash App, etc. The method 500 also includes transmitting, at operation 550, information about the second user to the banking system via the data channel to enable the banking system to complete the fund transfer to the second user.

In some embodiments, the biometric user data comprises at least one of voice data of the first user, facial data of the first user, or fingerprint data of the first user. In some embodiments, the information about the second user comprises a phone number of the second user and an amount of the fund for the fund transfer. For example, the mobile device is aware of the callee of the voice call (e.g., the second user). After the user states or enters the desired amount for the transfer, information about the callee number and the fund amount is transmitted to the banking system via the data channel so that the banking system can determine the callee's banking information. In some embodiments, the second user is a verified recipient of funds from the first user. A direct communication between the banking system(s) can be established to complete the transfer request. In some embodiments, the second user is not yet a verified recipient of funds from the first user. The first user can receive additional prompts in the call to verify and confirm the transfer to the second user.

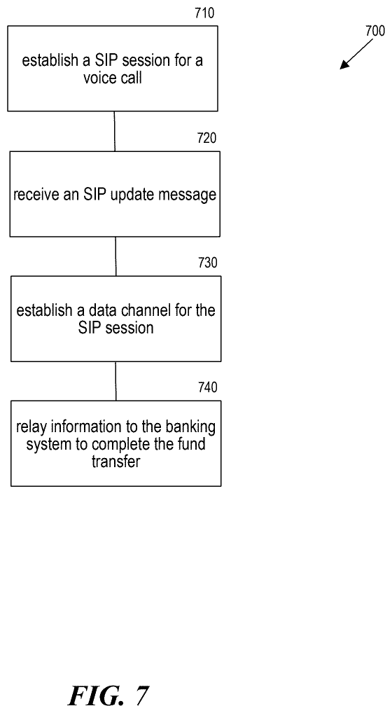

FIG. 7 is a flowchart representation of a method for wireless communication in accordance with one or more embodiments of the present technology. The method 700 includes establishing, by a network node at operation 710, a session initiation protocol (SIP) session for a voice call of a user. In the SIP session, the SDP payload carried in SIP messages usually uses the RTP or the SRTP to transmit media streams like voice and video. The method 700 includes receiving, by the network node at operation 720, an SIP update message to update the SIP session for the voice call. The method 700 includes establishing, by the network node at operation 730, an additional data channel for the SIP session for the voice call based on one or more parameters of the SIP update message. The data channel is separate from a channel for the session data transmitted using the SDP via TRP or SRTP, and is established for the transmission of authentication and/or financial information. The method also includes relaying, by the network node at operation 740, information about the first user to a banking system associated with the fist user using the data channel. The information comprises biometric user data of the first user to enable to the banking system to authenticate the user. The information further comprises information about the fund transfer (e.g., the recipient information, the transfer amount, etc.) to enable the banking system to complete the fund transfer to a second user.

In some embodiments, the method includes establishing, by the network node in response to the SIP update message, a second data channel associated with the second user for the SIP session of the voice call. For example, network carriers of both the first user and the second user support fund transfers during voice calls. Respective data channels can be established by carrier networks to complete the transfers.

In some embodiments, the biometric user data comprises at least one of voice data of the first user, facial data of the first user, or fingerprint data of the first user. In some embodiments, the information about the fund transfer comprises a phone number of the second user and an amount of the fund transfer. In some embodiments, to reduce risks in fund transfers, only small amounts of fund transfers are allowed during voice calls. The banking system(s) and/or the network carrier(s) can set a predetermined transfer limit/threshold (e.g., $50). In those cases, the first data channel is established upon the amount of the fund transfer being equal to or smaller than the predetermined threshold. If the amount exceeds the threshold, the user can receive a notification indicating the transfer amount limit.

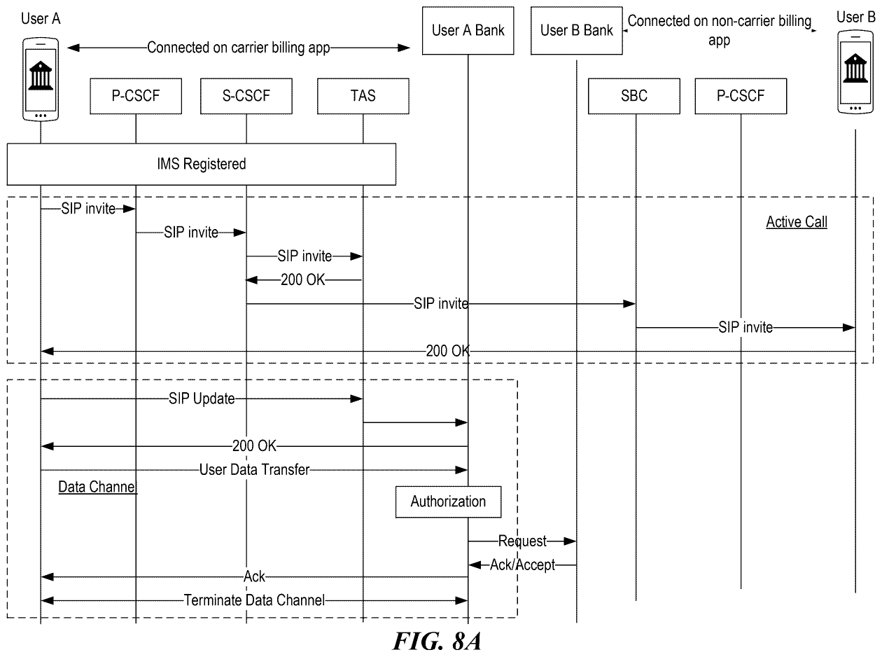

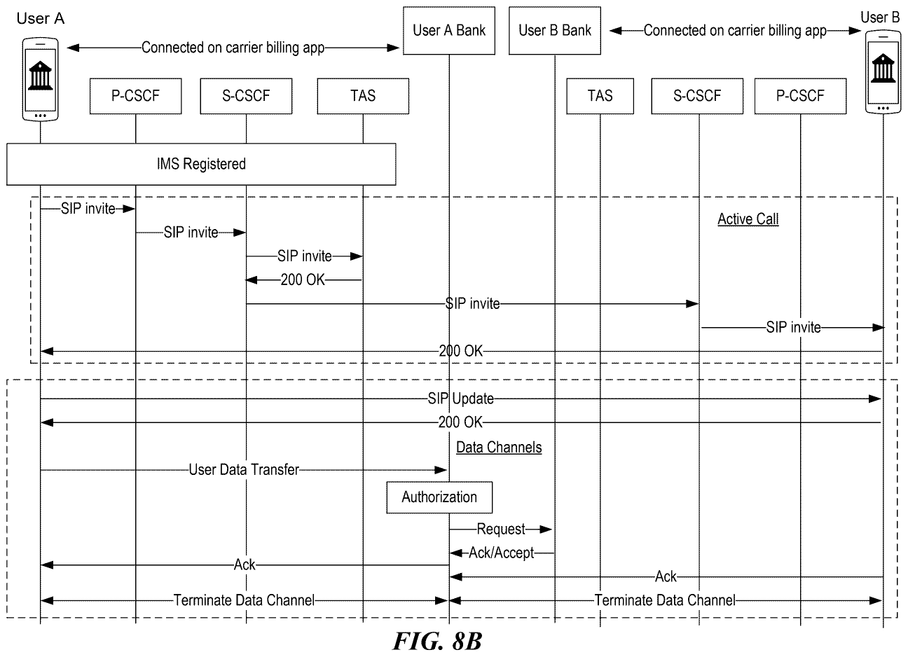

FIG. 8A illustrates an example signaling flow of a fund transfer during a voice call in accordance with one or more embodiments of the present technology. In this example, User A's carrier supports fund transfer during voice calls, but User B's carrier does not support such features. User A's banking system can be connected via a carrier billing app while User B's banking system is connected via a conventional third-party billing app (e.g. PayPal, Venmo).

As shown in FIG. 8A, User A has already completed IMS registration and makes a voice call to User B. User A transmits an SIP invite message as the caller to User B, the callee, to establish an SIP session for the voice call. The SIP invite message is transmitted and forwarded to various servers (e.g., P-CSCF, S-CSCF, etc.) to complete the session establishment. Once the session is established, the call content (e.g., voice data) can be transmitted using the RTP or SRTP, or any network protocol that delivers audio and video data over the internet reliably and efficiently in real time.

During the voice call, User A asks User B to help order lunch and initiates a fund transfer (e.g., $18) during the call. The fund transfer can be initiated by voice activation (e.g., by stating “I'd like to transfer $18 to you”) or by a simple tap on the voice call user interface, such as shown in FIGS. 6A-4C. Correspondingly, an SIP update message is transmitted to update the SIP session to establish a data channel for communication of information about the fund transfer.

Once the data channel is established, information of User A, as well as information of the fund transfer, can be transmitted to the banking system associated with User A to perform authentication and, upon successful authentication, the fund transfer. For example, in some embodiments, biometric data, such as voice, facial data, or fingerprints, can be used to authenticate the user. For example, voice data during the call from User A can be used to authenticate the identity of the user. In some cases, if User A is facing the mobile device while making the voice call, facial recognition can be used to authenticate the identity of the user. Alternatively, or in addition, if the device of User A supports fingerprint collection via the home button, fingerprint data can be used to authenticate the identity of the user.

After the authentication completes, User A's banking system can determine User B's banking information based on information such as User B's phone number. In this example, because User B's carrier does not support data channels for fund transfers during voice call, User A's banking system needs to have pre-established information about User B's banking information. For example, User B's account can be a pre-authorized/pre-verified recipient of User A such that User A's banking system can have direct communication with User B's banking system. User A's banking system then sends a transfer request to User B's banking system based on the pre-verified information. Upon successful transfer of the funds, User B's banking system can send an acknowledgement or acceptance message to User A's banking system, which is then forwarded to User A. In some embodiments, the data channel is terminated after the completion of the fund transfer.

FIG. 8B illustrates another example signaling flow of a fund transfer during a voice call in accordance with one or more embodiments of the present technology. In this example, both User A's network carrier and User B's network carrier support fund transfer during voice calls. User A's banking system can be connected via a carrier billing app and User B's banking system can be connected via a carrier billing app. In some embodiments, both users use the same network carrier.

As shown in FIG. 8B, User A has already completed IMS registration and makes a voice call to User B. User A transmits an SIP invite message as the caller to User B, the callee, to establish an SIP session for the voice call. The SIP invite message is transmitted and forwarded to various servers (e.g., P-CSCF, S-CSCF, etc.) to complete the session establishment. Once the session is established, the call content (e.g., voice data) can be transmitted using the RTP or SRTP, or any network protocol that delivers audio and video data over the internet reliably and efficiently in real time.

During the voice call, User A asks User B to help order a birthday present and initiates a fund transfer (e.g., $29) during the call. The fund transfer can be initiated by voice activation (e.g., by stating “I'd like to transfer $29 to you”) or by a simple tap on the voice call user interface, such as shown in FIGS. 6A-4C. Correspondingly, an SIP update message is transmitted to update the SIP session to establish a data channel for communication of banking information and/or information about the fund transfer.

Once the data channel is established, information of User A, as well as information of the fund transfer, can be transmitted to the banking system associated with User A to perform authentication and, upon successful authentication, the fund transfer. For example, in some embodiments, biometric data, such as voice, facial data, or fingerprints, can be used to authenticate the user, such as described above in connection with FIG. 8A. After the authentication completes, User A's banking system can determine User B's banking information based on information such as User B's phone number.

In this example, User B's carrier also supports data channels for fund transfers during voice call. One or more data channels can be established respectively to communicate fund transfer information. User A's banking system then sends a transfer request to User B's banking system via the established data channel(s). Upon successful transfer of the funds, User B's banking system can send an acknowledgement or acceptance message to User A's banking system, which is then forwarded to User A during the voice call. User B's banking system can also send an acknowledgement or a notification to User B during the voice call. This way, both caller and callee can obtain near-real-time acknowledgement or status report of the transaction. The data channels are terminated after the completion of the fund transfer.

Transfers between a user's own accounts can also be performed during an active call. In some embodiments, a transfer between the user's own accounts may be needed (e.g., to ensure sufficient funds) prior to a fund transfer to another user. In some embodiments, the user may initiate the fund transfer using a voice call to the bank instead of using the banking application. In some embodiments, the data channels established within voice call sessions not only support fund transfers between a user's different accounts and/or between accounts of different users, but also supports transmission of information about a line of credit request from the user's bank. For example, the user may initiate a small line of credit request (e.g., $200) using a voice call to the bank (e.g., while driving or during an emergency) instead of applying for the credit using the banking application. The user's bank then can authenticate the user and approve/deny the request based on the user's financial information.

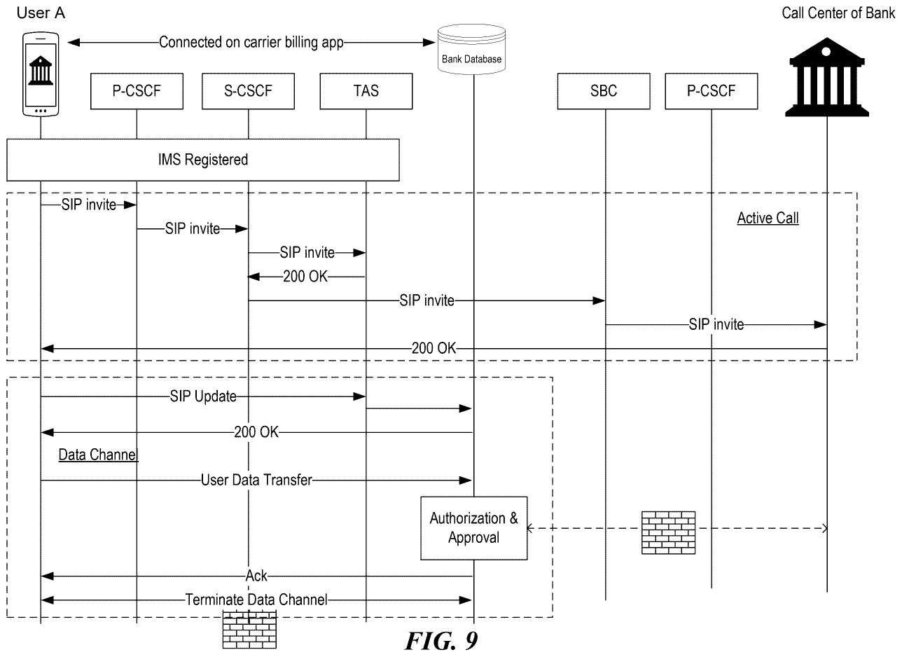

FIG. 9 illustrates an example signaling flow of obtaining a line of credit during a voice call in accordance with one or more embodiments of the present technology. User A has already completed IMS registration and makes a voice call to the call center of the bank. User A transmits an SIP invite message as the caller to bank, the callee, to establish an SIP session for the voice call. The SIP invite message is transmitted and forwarded to various servers (e.g., P-CSCF, S-CSCF, etc.) to complete the session establishment.

During the voice call, User A makes a line-of-credit request. The request can be initiated by voice activation (e.g., by stating “I'd like to apply for a line of credit”) or by a simple tap on the voice call user interface, such as shown in FIGS. 6A-4C. Correspondingly, an SIP update message is transmitted to update the SIP session to establish a data channel for communication of banking/financial information.

Once the data channel is established, information of User A, as well as information of the line-of-credit request, can be transmitted to the banking system associated with User A to perform authentication and, upon successful authentication, to process the request. For example, in some embodiments, biometric data, such as voice, facial data, or fingerprints, can be used to authenticate the user.

After the authentication completes, User A's banking system can determine whether the request can be approved based on the banking/financial information associated with User A. If the request can be approved, User A's banking system sends an acknowledgement or acceptance message to User A. In some embodiments, the data channel is terminated after the completion of the request. In some embodiments, a firewall and/or a security gateway can be provided for connections to the bank database and/or the bank network to ensure the secure exchange of user A's financial information.

### Computer System

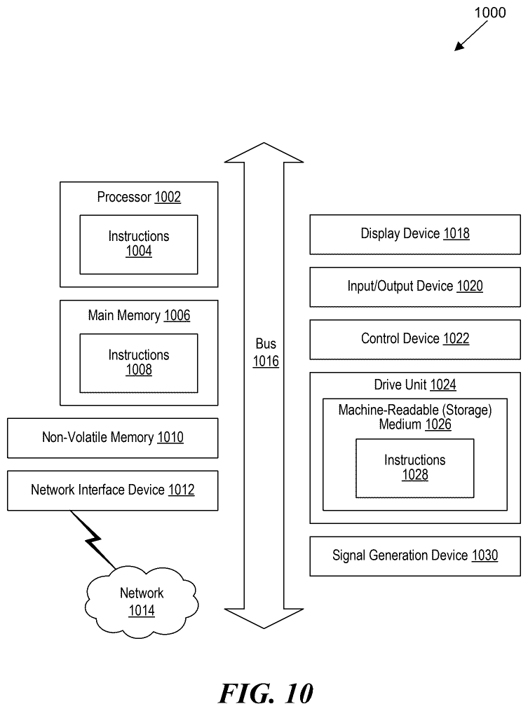

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for enabling a fund transfer during a voice call, comprising:
initiating, by a mobile device of a first user, a procedure to establish a session initiation protocol (SIP) session for the voice call, wherein session data of the SIP session is transmitted using a real-time transport protocol;
receiving, by the mobile device, an indication from the first user to initiate the fund transfer to a second user during the voice call;
transmitting, by the mobile device, a SIP update message to update the SIP session established for the voice call,
wherein the SIP update message comprises one or more parameters to establish a data channel between the mobile device and a banking system associated with the first user, and
wherein the data channel is configured to communicate information for the fund transfer and is separate from a channel for the session data transmitted using the real-time transport protocol;
transmitting, by the mobile device, biometric user data to the banking system via the data channel to enable the banking system to authenticate the first user; and
transmitting information about the second user to the banking system via the data channel to enable the banking system to complete the fund transfer to the second user.

2. The method of claim 1, wherein the indication comprises a voice activation command.

3. The method of claim 1, comprising:
providing an option via a user interface to the first user to enable the first user to make the indication.

4. The method of claim 1, wherein the biometric user data comprises at least one of voice data of the first user, facial data of the first user, or fingerprint data of the first user.

5. The method of claim 1, wherein the information about the second user comprises a phone number of the second user and an amount of the fund transfer.

6. The method of claim 1, wherein the second user is same as the first user.

7. The method of claim 1, wherein the second user is a verified recipient of funds from the first user.

8. A method for enabling a fund transfer during a voice call, comprising:
establishing, by a network node, a session initiation protocol (SIP) session of the voice call of a first user,
wherein session data of the SIP session is transmitted using a real-time transport protocol;
receiving, by the network node, an SIP update message to update the SIP session for the voice call;
establishing, by the network node, a first data channel between a mobile device of the first user and a banking system associated with the first user based on one or more parameters of the SIP update message, and
wherein the data channel is configured to communicate information for the fund transfer and is separate from a channel for the session data transmitted using the real-time transport protocol;
relaying, by the network node, information about the first user to the banking system associated with the first user using the first data channel,
wherein the information comprises biometric user data of the first user to enable to the banking system to authenticate the first user, and
wherein the information further comprises information about the fund transfer to enable the banking system to complete the fund transfer to a second user.

9. The method of claim 8, comprising:
establishing, by the network node in response to the SIP update message, a second data channel associated with the second user for the SIP session of the voice call.

10. The method of claim 8, wherein the biometric user data comprises at least one of voice data of the first user, facial data of the first user, or fingerprint data of the first user.

11. The method of claim 8, wherein the information about the fund transfer comprises a phone number of the second user and an amount of the fund transfer.

12. The method of claim 11, wherein the first data channel is established upon the amount of the fund transfer being equal to or smaller than a predetermined threshold.

13. The method of claim 8, wherein the second user is same as the first user.

14. The method of claim 8, wherein the second user is a verified recipient of funds from the first user.

15. A system for enabling a fund transfer during a voice call, comprising at least one processor that is configured to cause the system to:
establish a session initiation protocol (SIP) session of the voice call of a first user,
wherein session data of the SIP session is transmitted using a real-time transport protocol;
receive an SIP update message to update the SIP session for the voice call;
establish a first data channel between a mobile device of the first user and a banking system associated with the first user in response to the SIP update message,
wherein the data channel is configured to communicate information for the fund transfer and is separate from a channel for the session data transmitted using the real-time transport protocol;
relay information about the user to the banking system associated with the first user using the first data channel,
wherein the information comprises biometric user data of the first user to enable to the banking system to authenticate the first user, and
wherein the information further comprises information about the fund transfer to enable the banking system to complete the fund transfer to a second user.

16. The system of claim 15, wherein the at least one processor is configured to cause the system to:
establish a second data channel associated with the second user for the SIP session of the voice call.

17. The system of claim 15, wherein the biometric user data comprises at least one of voice data of the first user, facial data of the first user, or fingerprint data of the first user.

18. The system of claim 15, wherein the information about the fund transfer comprises a phone number of the second user and an amount of the fund transfer.

19. The system of claim 18, wherein the at least one processor is configured to establish the first data channel upon the amount of the fund transfer being equal to or smaller than a predetermined threshold.

20. The system of claim 15, wherein the system is part of a carrier network that provides service to both the first user and the second user.
